(19) United States
(12) Patent Application Publication
(10) Pub. No.: US 2013/0318171 A1
(43) Pub. Date: Nov. 28, 2013

(54) SYSTEM AND METHOD FOR SENDING A NOTIFICATION BASED UPON INFORMATION CONVEYED VIA UNILATERAL MESSAGING

(71) Applicant: Timothy L. Auen, Thornton, CO (US)

(72) Inventor: Timothy L. Auen, Thornton, CO (US)

(73) Assignee: WEST CORPORATION, Omaha, NE (US)

(21) Appl. No.: 13/479,779

(22) Filed: May 24, 2012

(51) Int. Cl. G06F 15/16

(52) U.S. Cl. 709/206

(57) ABSTRACT

A method for sending a notification based upon information conveyed via unilateral messaging includes: (a) receiving a plurality of unilateral messages; (b) gleaning selected information from selected unilateral messages of the plurality of unilateral messages; (c) evaluating the selected information according to predetermined criteria to ascertain a trend; (d) when the trend indicates the notification is justified, sending the notification; and (e) when the trend does not indicate the notification is justified, returning to receiving unilateral messages.

### FIELD OF THE INVENTION

The present invention is directed to emergency communication systems, and especially to sending notifications of emergency situations via an emergency communication system.

### BACKGROUND OF THE INVENTION

Notification of occurrence of an emergency situation, such as a natural disaster or a man-made disaster, may be normally received from official sources. Such official sources may include police, fire or emergency personnel; forest service personnel; military personnel; or other personnel occupying some official capacity whose duties include reporting occurrence of emergency situations or managing response to an emergency situation. For purposes of this disclosure, a natural disaster may be regarded as an event that results from some natural cause such as, by way of example and not by way of limitation, an earthquake, a tornado, a forest fire, a tsunami or a similar occurrence or event. For purposes of this disclosure, a man-made disaster may be regarded as an event that results from some man-made cause such as, by way of example and not by way of limitation, a bomb, an aircraft crash, an oil spill or a similar occurrence or event.

Official sources are not necessarily the only or the quickest means of notification that a disaster (natural or man-made) has occurred. For example, during an earthquake that occurred in August 2011 some Twitter (Twitter is a social media) users read about the earthquake seconds before feeling the tremor. This was attributed to the significantly slower propagation of seismic waves compared to the near-speed-of-light speed of Internet traffic. Twitter users in such cities as New York City and Boston reported reading “tweets” (i.e., social media messages sent via Twitter) about the Virginia earthquake from users in Washington, D.C., or Richmond, Va., 15 to 30 seconds before feeling the earthquake itself

For purposes of this disclosure, the term “unilateral communications” may be regarded as including any communication that is promulgated without an expectation of a return or response message. Such unilateral communications may include, by way of example and not by way of limitation, social media, broadcast television or radio, blogs (i.e., web logs) posted on the Internet or on other media, and similar communications.

Social media technologies may overlap other examples of unilateral communications and may be regarded as taking on many different forms including magazines, Internet forums, weblogs, social blogs, microblogging, wikis, podcasts, photographs or pictures, video, rating and social bookmarking. “Www.wikipedia.org” describes an article published by Kaplan and Haenlein in “Business Horizons” in 2010: According to Kaplan and Haenlein there are six different types of social media: collaborative projects (e.g., Wikipedia), vlogs (i.e. video blogs) and microblogs (e.g., Twitter), content communities (e.g., YouTube), social networking sites (e.g., Facebook), virtual game worlds (e.g., World of Warcraft), and virtual social worlds (e.g., Second Life). Technologies employed by social media may include: blogs, picture-sharing, vlogs, wall-postings, email, instant messaging, music-sharing, crowdsourcing (e.g., flash mobs) and voice over IP (VoIP), as well as others.

Social Media and other unilateral communications can be a source of information that may be more timely a reporter of events than may be achievable using more traditional emergency communications, such as police or fire reporting channels.

For purposes of illustration, by way of example and not by way of limitation, the present invention will be described in the context of an emergency service network in the United States, commonly referred to as a 9-1-1 network. The teachings of the present invention are equally applicable, useful and novel in other special number calling systems, such as maintenance service networks, college campus security networks, abbreviated number networks for calling commercial services and other networks.

Unilateral communications, including social media, may provide a more timely and rapid channel of notification that is presently available using more traditional, official communications. There is likely an associated need to ensure some verification of facts reported by such alternative channels is assured in order to preclude unnecessarily alerting or alarming a population.

There is a need for a system and method for sending a notification based upon information conveyed via unilateral messaging in order to provide more timely and rapid notification of emergency situations.

### SUMMARY OF THE INVENTION

A method for sending a notification based upon information conveyed via unilateral messaging includes: (a) receiving a plurality of unilateral messages; (b) gleaning selected information from selected unilateral messages of the plurality of unilateral messages; (c) evaluating the selected information according to predetermined criteria to ascertain a trend; (d) when the trend indicates the notification is justified, sending the notification; and (e) when the trend does not indicate the notification is justified, returning to receiving unilateral messages.

A system for sending a notification based upon information conveyed via social media messaging includes: (a) a receiving unit for receiving a plurality of social media messages; (b) a trend spotting unit coupled with the receiving unit; the trend spotting unit being configured for gleaning selected information from selected social media messages of the plurality of social media messages; the trend spotting unit evaluating the selected information according to predetermined criteria to ascertain a trend; and (c) a notification unit coupled with the trend spotting unit; the notification unit effecting notification of predetermined recipients when the trend indicates the notification is justified.

It is, therefore, a feature of the present invention to provide a system and method for sending a notification based upon information conveyed via unilateral messaging in order to provide more timely and rapid notification of emergency situations.

Further features of the present invention will be apparent from the following specification and claims when considered in connection with the accompanying drawings, in which like elements are labeled using like reference numerals in the various figures, illustrating the preferred embodiments of the invention.

### BRIEF DESCRIPTION OF THE DRAWINGS

FIG. 1 is a schematic illustration of a system for effecting the present invention.

FIG. 2 is a flow diagram illustrating the method of the present invention.

### DETAILED DESCRIPTION

For purposes of illustration, by way of example and not by way of limitation, the present invention will be discussed in the context of an emergency service network in the United States, commonly referred to as an E9-1-1 network. The teachings of the present invention are equally applicable, useful and novel in other special number calling systems, such as maintenance service networks, college campus security networks and other networks.

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

When the terms “coupled” and “connected”, along with their derivatives, are used herein, it should be understood that these terms are not intended as synonyms for each other. Rather, in particular embodiments, “connected” is used to indicate that two or more elements are in direct physical or electrical contact with each other. “Coupled” is used to indicated that two or more elements are in either direct or indirect (with other intervening elements between them) physical or electrical contact with each other, or that the two or more elements co-operate or interact with each other (e.g., as in a cause-and-effect relationship).

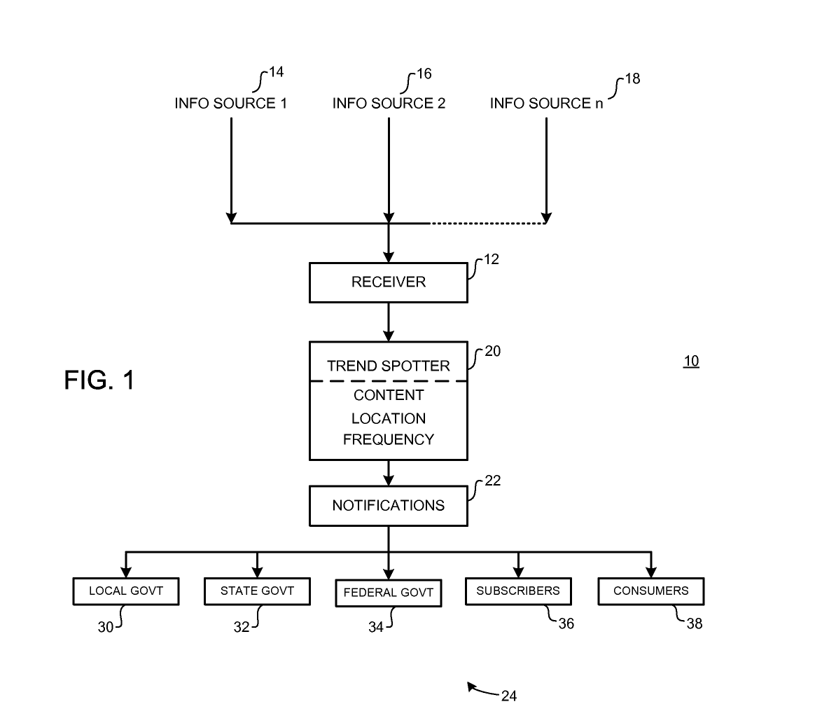

FIG. 1 is a schematic illustration of a system for effecting the present invention. In FIG. 1, a system 10 for sending a notification based upon information conveyed via a unilateral or social media communication includes a receiving unit 12 configured for receiving information from a plurality of sources Information Source1, 14; Information Source2, 16; and Information Sourcen, 18. The indicator “n” is employed to signify that there can be any number of information sources in system 10. The inclusion of three information sources 14, 16, 18 in FIG. 1 is illustrative only and does not constitute any limitation regarding the number of information sources that may be included in the system of the present invention. Throughout this description, use of a reference numeral using a generic subscript herein may be taken to mean that any respective member of the plurality of elements having the same reference numeral may be regarded as included in the description. Thus, by way of example and not by way of limitation, referring to Information Source n in describing FIG. 1 may be taken to mean that any Information Source—Information Source1, 14; Information Source2, 16; or Information Sourcen, 18 (FIG. 1)—may be regarded as capable of employment as described.

Each Information Source 14, 16, 18 is engaged in “unilateral communications” which may be regarded as including any communication that is promulgated without an expectation of a return or response message. Such unilateral communications may include, by way of example and not by way of limitation, social media, broadcast television or radio, blogs (i.e., web logs) posted on the Internet or on other media, and similar communications.

System 10 also includes a trend spotting unit 20 coupled with receiver unit 12. Trend spotting unit 20 is configured for gleaning selected information from Information Sources 14, 16, 18 such as, by way of example and not by way of limitation, using speech recognition, pattern recognition (including image recognition) or similar techniques. Recognized patterns may be subjected to predetermined criteria such as, by way of further example and not by way of limitation, whether the recognized term is on a predetermined watch list, or whether the Information Source 14,16, 18 indicates its respective information originates from a locus regarded as worthy of note or special attention.

Detecting and reacting to trends as opposed to reacting to individual unilateral messages provides some assurance of verification of facts reported by such alternative channels in order to preclude unnecessarily alerting or alarming a population. A trend worthy of attention (and, thus, worthy of issuing a notification) may be ascertained, by way of example and not by way of limitation, when a recognized term is recognized more than a predetermined number of times within a given time frame (i.e., whether the frequency of appearance of the recognized term appears with a greater frequency than a predetermined frequency). The word “or” is employed throughout this disclosure to indicate that an inclusive relation applies between terms or among terms. For example, the expression “A or B” intends to describe the relationship (1) A, or (2) B or (3) A and B.

A notification unit 22 is coupled with trend spotting unit 20. When trend spotting unit 20 recognizes a trend relating to a recognized term or terms is appropriate to warrant issuing a notification, notification unit 22 issues an appropriate notification to predetermined recipients 24. Predetermined recipients 24 may include local government agencies 30, state government agencies 32, federal government agencies 34, paid subscribers to a notification service 36 or consumers 38. Other entities such as, by way of example and not by way of limitation, business enterprises (e.g., companies) or educational organizations (e.g., university campuses) may also be included among predetermined recipients 24.

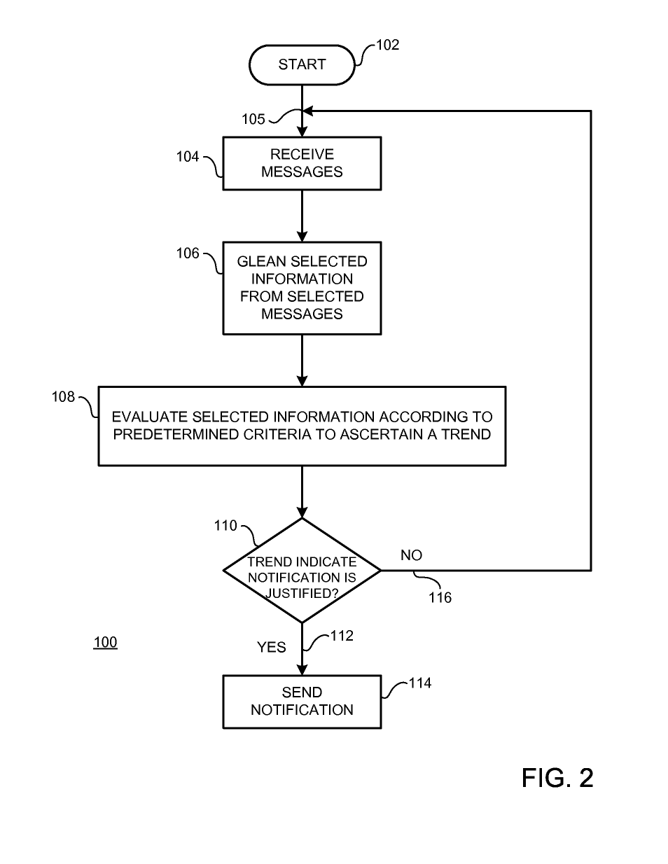

FIG. 2 is a flow diagram illustrating the method of the present invention. In FIG. 2, a method 100 for sending a notification based upon information conveyed via unilateral messaging begins at a START locus 102. Method 100 continues with receiving a plurality of unilateral messages, as indicated by a block 104.

Method 100 continues with gleaning selected information from selected unilateral messages of the plurality of unilateral messages, as indicated by a block 106.

Method 100 continues with evaluating the selected information according to predetermined criteria to ascertain a trend, as indicated by a block 108.

Method 100 continues by posing a query whether the trend indicates the notification is justified, as indicated by a query block 110. Determination whether an ascertained trend indicates that a notification is justified may be decided according to predetermined criteria established to support the decision represented by query block 110. When the ascertained trend indicates the notification is justified, method 100 proceeds from query block 110 via a YES response line 112 and a notification is effected, as indicated by a block 114.

When the trend indicates the notification is not justified, method 100 proceeds from query block 110 via a NO response line 116 to a locus 105 and thereafter proceeds as previously described in connection with blocks 104, 106, 108, 110.

It is to be understood that, while the detailed drawings and specific examples given describe embodiments of the invention, they are for the purpose of illustration only, that the system and method of the invention are not limited to the precise details and conditions disclosed and that various changes may be made therein without departing from the spirit of the invention which is defined by the following claims:

1. A method for sending a notification based upon information conveyed via social media messaging; the method comprising:
(a) receiving a plurality of social media messages;
(b) gleaning selected information from selected social media messages of said plurality of social media messages;
(c) evaluating said selected information according to predetermined criteria to ascertain a trend;
(d) when said trend indicates said notification is justified, sending said notification; and
(e) when said trend does not indicate said notification is justified, returning to step (a).

2. The method for sending a notification based upon information conveyed via social media messaging as recited in claim 1 wherein said trend indicates said notification is justified when said selected information indicates a likelihood of occurrence of a natural disaster.

3. The method for sending a notification based upon information conveyed via social media messaging as recited in claim 2 wherein said natural disaster is indicated as occurring within a predetermined geographic area.

4. The method for sending a notification based upon information conveyed via social media messaging as recited in claim 1 wherein said trend indicates said notification is justified when said selected information indicates a likelihood of occurrence of at least one of a natural disaster and a man-made disaster.

5. The method for sending a notification based upon information conveyed via social media messaging as recited in claim 1 wherein said selected information relates to content of said selected social media messages.

6. The method for sending a notification based upon information conveyed via social media messaging as recited in claim 1 wherein said selected information relates to content and locus of origin of said selected social media messages.

7. The method for sending a notification based upon information conveyed via social media messaging as recited in claim 1 wherein said selected information relates to content and frequency of occurrence of said selected social media messages.

8. A system for sending a notification based upon information conveyed via social media messaging; the system comprising:
(a) a receiving unit for receiving a plurality of social media messages;
(b) a trend spotting unit coupled with said receiving unit; said trend spotting unit being configured for gleaning selected information from selected social media messages of said plurality of social media messages; said trend spotting unit evaluating said selected information according to predetermined criteria to ascertain a trend; and
(c) a notification unit coupled with said trend spotting unit; said notification unit effecting notification of predetermined recipients when said trend indicates said notification is justified.

9. The system for sending a notification based upon information conveyed via social media messaging as recited in claim 8 wherein said trend indicates said notification is justified when said selected information indicates a likelihood of occurrence of a natural disaster.

10. The system for sending a notification based upon information conveyed via social media messaging as recited in claim 9 wherein said natural disaster is indicated as occurring within a predetermined geographic area.

11. The system for sending a notification based upon information conveyed via social media messaging as recited in claim 8 wherein said trend indicates said notification is justified when said selected information indicates a likelihood of occurrence of at least one of a natural disaster and a man-made disaster.

12. The system for sending a notification based upon information conveyed via social media messaging as recited in claim 8 wherein said selected information relates to content of said selected social media messages.

13. The system for sending a notification based upon information conveyed via social media messaging as recited in claim 8 wherein said selected information relates to content and locus of origin of said selected social media messages.

14. The system for sending a notification based upon information conveyed via social media messaging as recited in claim 8 wherein said selected information relates to content and frequency of occurrence of said selected social media messages.

15. A method for sending a notification based upon information conveyed via unilateral messaging; the method comprising:
(a) receiving a plurality of unilateral messages;
(b) gleaning selected information from selected unilateral messages of said plurality of unilateral messages;
(c) evaluating said selected information according to predetermined criteria to ascertain a trend;
(d) when said trend indicates said notification is justified, sending said notification; and
(e) when said trend does not indicate said notification is justified, returning to step (a).

16. The method for sending a notification based upon information conveyed via unilateral messaging as recited in claim 15 wherein said trend indicates said notification is justified when said selected information indicates a likelihood of occurrence of a natural disaster.

17. The method for sending a notification based upon information conveyed via unilateral messaging as recited in claim 16 wherein said natural disaster is indicated as occurring within a predetermined geographic area.

18. The method for sending a notification based upon information conveyed via unilateral messaging as recited in claim 15 wherein said trend indicates said notification is justified when said selected information indicates a likelihood of occurrence of at least one of a natural disaster and a man-made disaster.

19. The method for sending a notification based upon information conveyed via unilateral messaging as recited in claim 15 wherein said selected information relates to content of said selected unilateral messages.

20. The method for sending a notification based upon information conveyed via unilateral messaging as recited in claim 15 wherein said selected information relates to at least one of content of said selected unilateral messages, frequency of occurrence of said selected social media messages and locus of origin of said selected unilateral messages.
